(19) United States
(12) Patent Application Publication
(10) Pub. No.: US 2020/0238336 A1
(43) Pub. Date: Jul. 30, 2020

(54) SCREENING APPARATUS

(71) Applicant: Axiom Process Limited, Newcastle Upon Tyne (GB)

(72) Inventor: Marshall Graham BAILEY, Dubai (AE)

(21) Appl. No.: 16/340,255

(22) PCT Filed: Oct. 6, 2017
(86) PCT No.: PCT/GB2017/053026

§ 371 Date: Apr. 8, 2019

(30) Foreign Application Priority Data
Oct. 7, 2016 (GB) 1617106.8

(51) Int. Cl. B07B 1/42; B06B 1/16

(52) U.S. Cl. CPC B07B 1/42; B07B 1/46; B06B 1/166

(57) ABSTRACT

A basket (1) for a shale shaker includes a front, solids discharge end (34) and a rear, feed end (36) spaced apart by opposed first and second sides (2,4). The first and second sides mount a drive mechanism (7). The drive mechanism includes a first eccentrically weighted shaft (12), mounted to the first side (2) of the basket for rotation about an axis transverse to the front to rear direction of the basket; a first shaft drive, coupled to the first shaft (12) and to a corresponding second eccentrically weighted shaft (12a), which is mounted to the second side of the basket (4) for rotation about an axis transverse to the front to rear direction of the basket. A drive module (48, 50) comprising two eccentrically weighted shafts mounted on bearings in a single housing (52) is also described.

### FIELD OF THE INVENTION

The invention relates to shale shakers as used for example for separating drill cuttings from used drilling mud when drilling operations such as drilling an oil well are being carried out. In particular the invention relates to the vibratory drive mechanisms used to achieve solids and liquid separation in the basket of shale shaker machines.

### BACKGROUND TO THE INVENTION

Shale shakers are vibratory screening machines that include a vibratory basket mounted on a base by means of resilient mounts such as springs or rubber blocks.

The basket is typically generally cuboid in form. The basket has a solids discharge end, typically described as the front of the basket and a rear feed end typically described as the rear or the back of the basket. Two sides complete the generally cuboid shape.

A screen deck or screen decks within the basket mount screening surfaces, typically of one or more panels of a wire mesh or meshes tensioned across a suitable support frame. Where multiple screen decks are provided, one stacked above the other, the screening surfaces will normally have meshes of successively finer cut, to provide progressive screening as an applied mixture of drill cuttings and drilling mud is processed through the machine.

The mixture of drill cuttings and drilling mud is fed into the machine at or near the rear end of the basket and the screening surfaces then separate solids from the mixture that are larger than the apertures in the screen mesh employed. This separation is aided by vibratory motion applied to the basket. The vibratory motion aids in passing fluid and unscreened solids through the screening surfaces to reach the bottom of the basket. At the same time the vibratory motion transports (“walks”) solids collected on the screening surfaces towards and then off the solids discharge end, at the front of the basket.

To achieve good screening and solids transport along the screening surfaces various types of vibratory motion: linear, orbital (circular or elliptical) or combinations of vibratory motion are applied to the basket. With application of suitable vibratory motion solids walk to the discharge end of the basket when the screening surfaces are inclined either upwards or downwards, from the rear to the front of the basket.

The vibratory motion is typically applied by means of electrically driven rotating members, or shafts with eccentric weighting. Other types of power may be used, for example hydraulic or gas powered motors. A typical prior art arrangement is shown in the schematic drawings of FIGS. 1a to 1c. In this arrangement a pair of eccentrically weighted shafts each extends across the basket of a shale shaker on a rigid bridge or as part of the basket structure.

The weighting of these shafts and their relative positioning determines the vibratory motion imparted to the basket and hence to the screening surfaces and to solids and liquids applied thereon. It is also known to have shafts rotating in the same direction or contra rotatory, to provide different types of vibratory motion. The arrangements of FIGS. 1a to 1c are discussed in more detail hereafter for comparison with the arrangements of the present invention.

Arrangements such as those of FIGS. 1a to 1c can be effective, but they are relatively heavy and the bearings mounting the eccentrically weighted shafts are subject to wear due to flexing or bending forces. The relatively bulky arrangement also tends to be mounted relatively high on the basket so as not to interfere with access to the screening surfaces, resulting in a relatively high basket. This can be inconvenient where head height is limited.

Other arrangements are known for example motor driven vibratory devices such as rotating members may be fitted to the outside faces of each of the sides of the basket each applying vibratory motion to the basket. This arrangement has the disadvantage of adding to the basket width and may apply significant bending forces to the basket sides. Other known arrangements that may apply unwanted bending forces to a basket include those where a vibratory drive has its mass located on a bridge between basket sides. Such prior art arrangements are discussed further hereafter in respect of FIGS. 1d and 1 e.

Shale shakers are becoming more complex, being provided with multiple screen decks and having increased capability given by flow distributors and solids collection arrangements.

There is therefore a need for shale shakers including improved basket and vibratory motion arrangements.

### DESCRIPTION OF THE INVENTION

According to a first aspect the present invention provides a basket for a shale shaker, the basket comprising a front, solids discharge end and a rear, feed end spaced apart by opposed first and second sides;

wherein the first and second sides mount a drive mechanism comprising:
a) a first eccentrically weighted shaft, mounted to the first side of the basket for rotation about an axis transverse to the front to rear direction of the basket;
b) a first shaft drive, coupled to the first shaft and to;
c) a corresponding second eccentrically weighted shaft, mounted to the second side of the basket for rotation about an axis transverse to the front to rear direction of the basket.

Conveniently the first and second eccentrically weighted shafts may be mounted for rotation about a substantially horizontal axis transverse to the front to rear direction of the basket. It will be understood that there may be some deviation from exactly horizontal in such an arrangement, for example of 5 or 10 degrees from the horizontal.

The first and second eccentrically weighted shafts are typically rotated by means of an electric motor or motors. Alternatively rotation may be by hydraulic or even gas powered motor or motors. As the shafts are connected by the first shaft drive, motor drive to one of the eccentrically weighted shafts or to a shaft of the shaft drive may be sufficient and advantageous in reducing mechanical complexity. Conveniently a motor such as an electric motor drives the first eccentrically weighted shaft, for example, by means of a belt or a gear drive. Conveniently the motor is mounted to the side of the basket in the same plane, parallel to the front to rear axis of the basket, as the eccentrically weighted shaft that it drives.

The rotation of the first and second eccentrically weighted shafts causes vibratory motion to the basket. As the first and second shafts are mounted to their respective side of the basket the vibratory motion acts more or less directly on the basket sides.

Advantageously the eccentrically weighted shafts are each mounted so as to have the eccentric weighting in the plane of the corresponding first or second basket side. Advantageously the eccentrically weighted shafts are each mounted so as to have the centre of mass of the eccentrically weighted shaft substantially in the plane of the corresponding first or second basket side. These arrangements allow more or less direct transmission of the vibratory action into the sides of the basket, avoiding applying substantial inwards or outwards bending forces to the basket.

Advantageously the drive mechanism further includes a second pair of eccentrically weighted shafts, third and fourth shafts. These can provide desirable motion such as linear, orbital (circular or elliptical) or combinations thereof in the same way as a more conventionally arranged drive mechanism such as shown in the prior art arrangement of FIG. 1.

Thus the basket may have a drive mechanism further comprising:

d) a third eccentrically weighted shaft, mounted to the first side of the basket for rotation about an axis transverse to the front to rear direction of the basket;
e) a second shaft drive, coupled to the third shaft and to;
f) a corresponding fourth eccentrically weighted shaft, mounted to the second side of the basket for rotation about an axis transverse to the front to rear direction of the basket.

This second pair of eccentrically weighted shafts may have all the same features of the first and second eccentrically weighted shafts arrangement, including motor drive e.g. a motor driving the third or the fourth eccentrically weighted shaft, for example, by means of a belt or a geared drive. Conveniently the motor may be mounted above the eccentrically weighted shaft that it drives. For further example the third and fourth eccentrically weighted shafts may conveniently be mounted for rotation about a substantially horizontal axis transverse to the front to rear direction of the basket.

In a convenient arrangement where the second pair of eccentrically weighted shafts are provided a motor drives the first shaft and is mounted to the first side of the basket and a second motor drives the fourth shaft and is mounted to the second side of the basket. Thus the masses of the two motors are provided on either basket side, giving a generally balanced arrangement.

The direction of rotation of the two pairs of eccentrically weighted shafts may be in the same direction or one pair may rotate contra rotatory to the other pair. The weighting arrangement of one pair of eccentrically weighted shafts may differ from that of the other. By such means the vibratory motion applied to the basket may be adjusted in the known manner.

As with the first and second eccentrically weighted shafts mounting the third and fourth shafts so as to have their eccentric weighting in the plane of the corresponding first or second basket side is advantageous. Advantageously the eccentrically weighted shafts are each mounted so as to have the centre of mass of the eccentrically weighted shaft substantially in the plane of the corresponding first or second basket side.

The shaft drives couple each of pair of eccentrically weighted shafts. They allow only one of a pair of eccentrically weighted shafts to be driven by motor and also ensure synchronisation of rotation between the pairs of weighted shafts. Conveniently either or both of the shaft drives may each include at least one coupling accommodating misalignment between the eccentrically weighted shafts. This avoids wear or unwanted vibration that may occur if a rigid shaft drive arrangement is employed between a pair of eccentrically weighted shafts.

Conveniently the first shaft drive comprises a first drive shaft coupling at a first end to the first shaft and at a second end to the second shaft; wherein the couplings are universal joints or constant velocity joints; and, where they are fitted the second shaft drive comprises a second drive shaft coupling at a first end to the third shaft and at a second end to the fourth shaft; wherein the couplings are universal joints or constant velocity joints.

Thus the shaft drives may each include only one shaft, connected at each end by universal joint or constant velocity joint to the respective eccentrically weighted shaft. This arrangement can give smooth drive between the coupled eccentrically weighted shafts and can be light weight and of low bulk.

The shafts of shaft drives may be tubes, to further reduce mass not directly at or on a side of the basket. For example carbon fibre composite or glass fibre composite tubes may be employed as drive shafts.

The arrangements described above have notable advantages. The eccentrically weighted shafts can be short and compact. Each can be mounted for rotation in bearings to either side of the shaft and close together forming a compact strong and reliable structure.

The eccentric weighting of a shaft may be provided at or near the midpoint along its length. Eccentric weighting may be provided, for example, by providing a radially extending arm on the shaft. The radially extending arm may be at or near the midpoint along the length of the shaft. The arm itself will provide eccentric weighting, but may also carry a weight or weights, typically distal to the shaft, to increase the weighting. The weights, may be replaceable, to allow adjustment of the degree of eccentric weighting. The bearings employed to allow rotation may be close to and to either side of the eccentrically weighted part of shaft, for example to either side of a radially extending arm.

In a convenient arrangement bearings support the eccentrically weighted shaft to either side of a radially extending arm that carries weighting which extends axially i.e. in the same direction as the shaft. The axial extension of the weight or weights may be to or past the position radially opposite the bearings to either side of the arm. Such an arrangement can be compact and durable. The bearings to either side of the arm provide close support to the part of the shaft directly stressed by the action of the rotating weight or weights.

The eccentrically weighted shafts can be mounted to the side of the basket in various ways. For example the shaft, mounted in bearings can have a base or a housing into which the bearings are fitted. The base or the housing may bolt onto or be otherwise secured (e.g. by welding) to a basket side. For example to a top side edge or a flange on a top side edge of the basket side.

Housings may be employed about the eccentrically weighted shafts and the shaft drives to prevent contact, in normal operations, between moving machinery and an operator. Where the bearings of an eccentrically weighted shaft are fitted to a base, then a separate housing may be provided about the eccentrically weighted shaft to provide protection for an operator from the moving parts.

Where two pairs of eccentrically weighted shafts are employed in a drive mechanism; then a single housing or base may be used on each basket side i.e. a single housing or base is fitted with bearings to mount both of the eccentrically weighted shafts on the first basket side and the same arrangement can be provided on the second basket side. In such an embodiment the shaft drives between each pair of eccentrically weighted shafts may be housed in one housing or separate, typically tubular, housings.

A module including two eccentrically weighted shafts mounted on bearings is convenient and is described further hereafter with reference to a specific embodiment. The module may have the two eccentrically weighted shafts mounted on bearings in a single housing. The module may include a drive motor for driving one of the eccentrically weighted shafts. Such a module can be made so as to be useable on either the first or the second side of the basket i.e. the module is not ‘left handed or right handed,’ and so a reduced inventory of spares can be kept.

The basket side may be shaped to allow easy mounting of each eccentrically weighted shaft in the desired location. For example each side of the basket may be shaped to provide locations, for attaching two eccentrically weighted shafts where two pairs are being used, at different heights.

Alternatively each side of the basket may include a platform, that may be in the form of a substantially horizontal plate or flange of the side, to which the bases or housings of the eccentrically weighted shafts are attached e.g. by bolts or other releasable fixings, or by welding or other permanent fixing. Where it is desired that two pairs of eccentrically weighted shafts are to be fixed to the basket at different heights; then spacer pieces maybe used to raise one pair of the eccentrically weighted shafts higher than the other pair. Where used the platform may be of sufficient length to allow fixing of the eccentrically weighted shafts at different locations—further towards or away from the rear of the basket. This can allow adjustment of the angle and location of vibratory motion applied to the basket.

Where a platform is fitted to support bases or housings of the eccentrically weighted shafts, it may be sloped from the horizontal to provide a height difference along the length of the platform. A convenient arrangement is a generally V shaped platform, with each arm of the V providing an upwards facing surface that may be employed for supporting or locating bases or housings. The V shaped platform may be formed from plates or flanges of the basket sides. The V shaped platform may be employed to mount housings or bases for one or more eccentrically weighted shaft. Such an arrangement can be conveniently used to mount a module including two eccentrically weighted shafts mounted on bearings and, typically, a drive motor for driving one of the eccentrically weighted shafts, as discussed further hereafter.

The sides of a shale shaker basket are typically of sheet steel. The drive mechanisms described herein act more or less directly on the first and second sides of the basket. Conveniently the first and second sides of the basket may each be reinforced by one or more ribs, typically of sheet steel. The ribs may be spaced apart and may be substantially parallel. The ribs may support a platform that mounts the eccentrically weighted shaft(s). The ribs may slope downwards from a top edge of the basket side towards the bottom edge, in a direction towards the back (feed receiving end) of the basket. Such a downwards sloping angle, towards the back end of the basket, may approximate the typical angle of the vibratory motion applied to the basket. Thus the ribs can provide strong reinforcement to the basket sides.

According to a second aspect the present invention provides a drive mechanism for the basket of a shale shaker comprising:

a) a first shaft, eccentrically weighted and mountable in use to the first side of a shale shaker basket for rotation about an axis transverse to the front to rear direction of the basket;
b) a first shaft drive, coupled to the first shaft and to;
c) a corresponding second eccentrically weighted shaft, mountable in use to a second side of the shale shaker basket, opposite the first side, for rotation about an axis transverse to the front to rear direction of the basket.

The drive mechanism of the second aspect can include any or all of the drive mechanism features discussed herein with respect to the first aspect of the invention, including third and fourth eccentrically weighted shafts and a corresponding shaft drive coupling between. Where four eccentrically weighted shafts are employed, the drive mechanism may include two modules, each including two eccentrically weighted shafts mounted on bearings and may include a drive motor for driving one of the eccentrically weighted shafts. The modules are mounted to a respective basket side with the drive shafts of the shaft drives connecting between the modules.

### BRIEF DESCRIPTION OF THE DRAWINGS

FIGS. 1a, 1b, 1c, 1d and 1e show various aspects of prior art shale shaker baskets with prior art drive mechanisms;

FIGS. 2a and 2b show in schematic views a shale shaker basket and a drive mechanism of the invention;

FIGS. 3a and 3b show in schematic views the sides of a shale shaker basket fitted with a drive mechanism of the invention;

FIGS. 4a and 4b show in schematic perspective views a shale shaker basket fitted with a drive mechanism of the invention;

FIG. 5a shows in schematic perspective a shale shaker basket fitted with a drive mechanism of the invention;

FIG. 5b is a side elevation of the basket of FIG. 5a;

FIG. 5c is a schematic cross section of a module housing showing an eccentrically weighted shaft of a drive module within; and

FIG. 5d shows the interior of the module of FIG. 5c in side elevation, showing the two eccentrically weighted shafts of a drive module within.

### DESCRIPTION OF SOME EMBODIMENTS BY WAY OF EXAMPLE

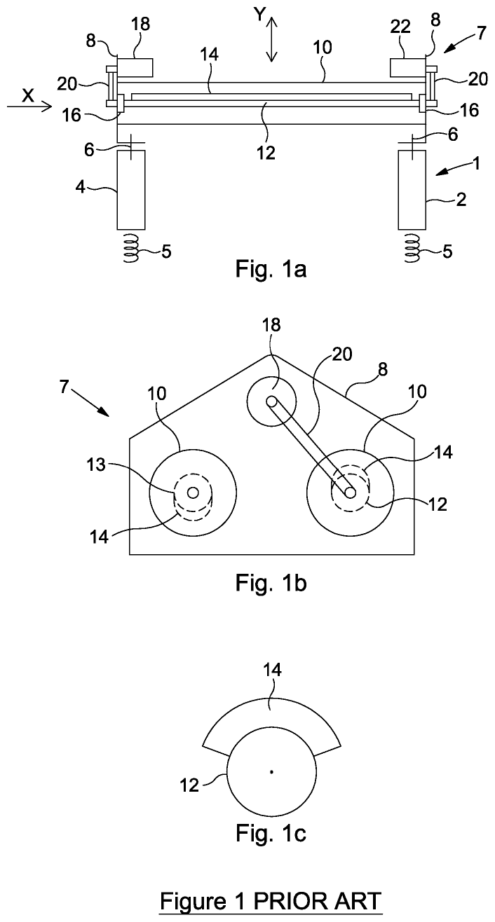

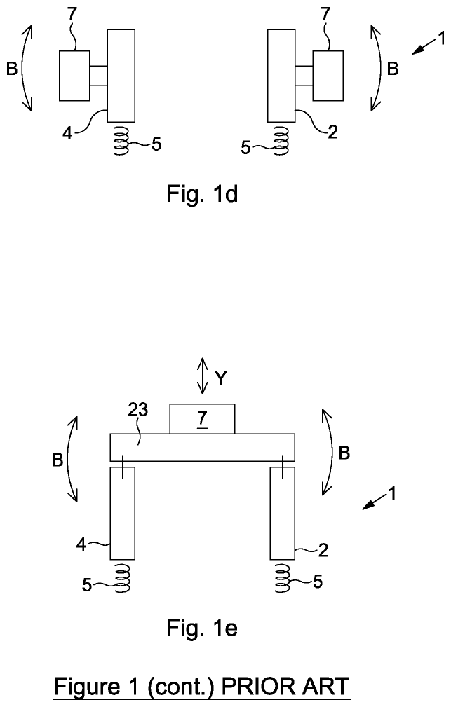

FIG. 1a shows in schematic end elevation parts of a prior art basket 1 of a shale shaker. The first and second sides 2,4 of the basket 1 are shown viewed from the front solids discharge end (not shown in this figure). The sides 2,4 are supported on springs 5 in the usual way to allow vibratory motion.

Mounted to the sides of the basket by bolts 6 is a drive mechanism 7 for imparting vibratory motion to the basket 1. The drive mechanism 7 includes supporting end plates 8 with a pair of casing tubes 10 forming a bridge from one basket side 2 to the other 4. Within each casing tube 10 is a shaft 12,13 that has an eccentric weight 14 provided along its length. See cross section of shaft and weight in FIG. 1c. Only one casing tube 10 and its contents is visible in FIG. 1a as, in this example, the shafts are at the same height. FIG. 1b shows mechanism 7 as viewed from direction X.

Shafts 12 are mounted in bearings 16. An electric motor 18 drives the shaft 12 visible in FIG. 1a by belt 20. A corresponding motor 22 at the other side of the drive 7 powers the second shaft 13. The drive mechanism 7 is substantial in weight with casings 10 and end plates 8 constructed of metal (steel) to support the masses and forces involved.

In use rotation of shafts 12,13 imparts vibratory motion, for example elliptical vibratory motion to the basket 1 by virtue of the motion of the eccentric weights 14. The direction and type of vibratory motion imparted to the basket 1 depends on factors including: the spacing between shafts 12,13; the mass and relative angular displacement of weights 14; the rotational speeds of the shafts; and the rotational direction of the shafts. As suggested by double headed arrow Y in FIG. 1a the rotation of eccentric weight 14 imparts significant bending force on shaft 12 and hence stress on bearings 16.

FIGS. 1d and 1 e illustrate schematically two other prior art arrangements.

In FIG. 1d each side 2, 4 of the basket 1 has a drive mechanism 7 attached to its outer side. The mechanisms 7 have moving members such as eccentrically weighted, shafts driven by electric motor, to impart vibratory motion. As suggested by double headed arrows B, the location of the relatively massive drive mechanisms 7 can impart significant bending motion to the basket sides 2,4.

In FIG. 1e a bridge 23 between basket sides 2, 4 carries a drive mechanism 7. The mechanism 7 has a moving member or members such as eccentrically weighted, shafts driven by electric motor, to impart vibratory motion. The location of the mechanism 7 mid way between the basket sides 2,4 can impart significant bending motions B to the basket sides.

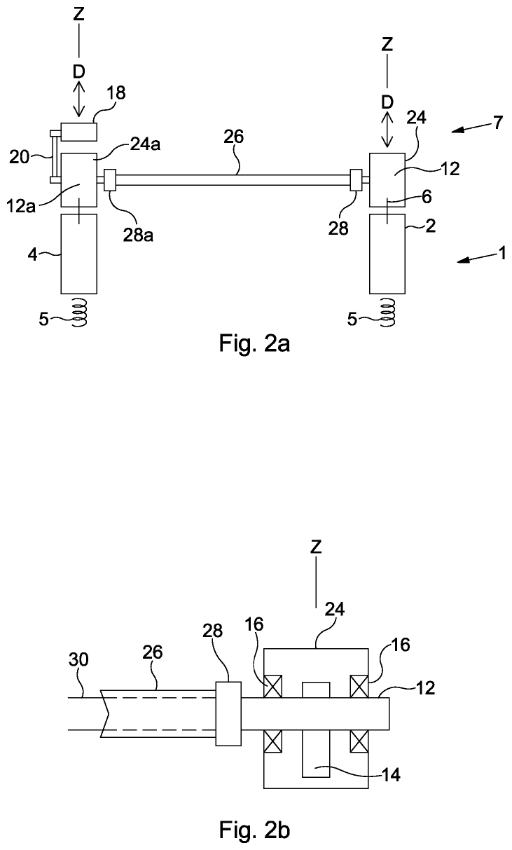

FIG. 2a shows a basket 1 in a similar schematic view to that of FIG. 1a but provided with a drive mechanism 7 in accordance with an embodiment of the invention. Drive mechanism 7 includes housings 24, 24a connected by tubing 26 and coupling housings 28, 28a. As shown in partial detail schematic FIG. 2b the housing 24 mounted to basket side 2 contains a short shaft 12 mounted on bearings 16 to either side and carrying an eccentric weight 14. Eccentrically weighted shaft 12 is coupled by a universal joint (not shown) inside coupling housing 28 to a tubular drive shaft 30 inside tubing 26 that acts as its housing. The drive shaft 30 connects to a corresponding eccentrically weighted shaft 12a in housing 24a mounted to basket side 4 via a further universal joint in the coupling housing 28a. The pair of eccentrically weighted shafts 12 and 12a are coupled by the shaft drive including shaft 30 and the universal joints. The arrangement is driven by electric motor 18 via belt drive 20.

As suggested by double headed arrows D the vibratory motion provided by each eccentrically weighted shaft acts directly on the basket sides 2,4 as the mass of shafts 12, 12a and associated weights 14 is positioned above respective basket sides. The eccentrically weighted shafts are each mounted so as to have the eccentric weighting in the plane of the corresponding first or second basket side as indicated by lines Z. In this example the centre of mass of each eccentrically weighted shaft is in the plane of the corresponding basket side.

The short shafts 12, 12a tend to produce less wear on bearings 16 as they are less prone to significant bending. Drive shaft 30 and associated universal joints provide a shaft drive arrangement that can be lightweight as it is not heavily loaded. Similarly housings 26 and 28 are not bearing a significant load and can be light, providing only separation of moving parts from an operator, for safety.

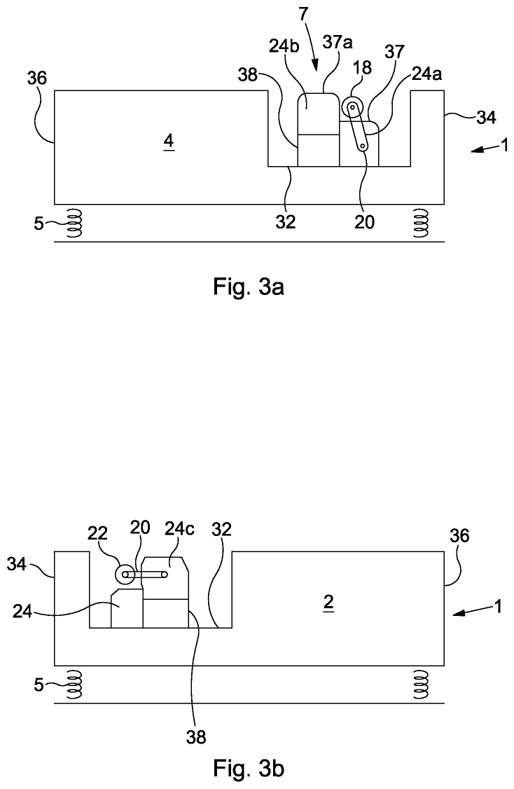

FIGS. 3a and 3b show in schematic elevation first and second sides 2, 4 of a shale shaker basket including a drive system 7 incorporating two of the drive arrangements of the type illustrated in FIGS. 2a and 2b.

In this example the housings 24 of drive system 7 sit on (are bolted to) a lowered edge or platform 32 of each basket side 2,4 which in this example is towards the front, solids discharge end 34 of the basket, and somewhat further away from the rear, feed end 36. A first drive arrangement 37 has housings 24, 24a including eccentrically weighted shafts and coupled via a drive shaft in the same way as illustrated in FIGS. 2a and 2b. Drive is provided by electric motor 18 and belt drive 20 located on basket side 4.

The second drive arrangement 37a has housings 24b and 24c including eccentrically weighted shafts and coupled via a drive shaft in the same way as illustrated in FIGS. 2a and 2b. Drive is provided by electric motor 22 and belt drive 20 located on basket side 2. In this example the second drive arrangement 37a is elevated by being mounted to the basket sides via platforms 38. Changing the relative positions of the drive arrangements along lowered edges 32 and/or their heights relative to each other can be used to adjust the vibratory motion (type and direction) imparted to the basket 1.

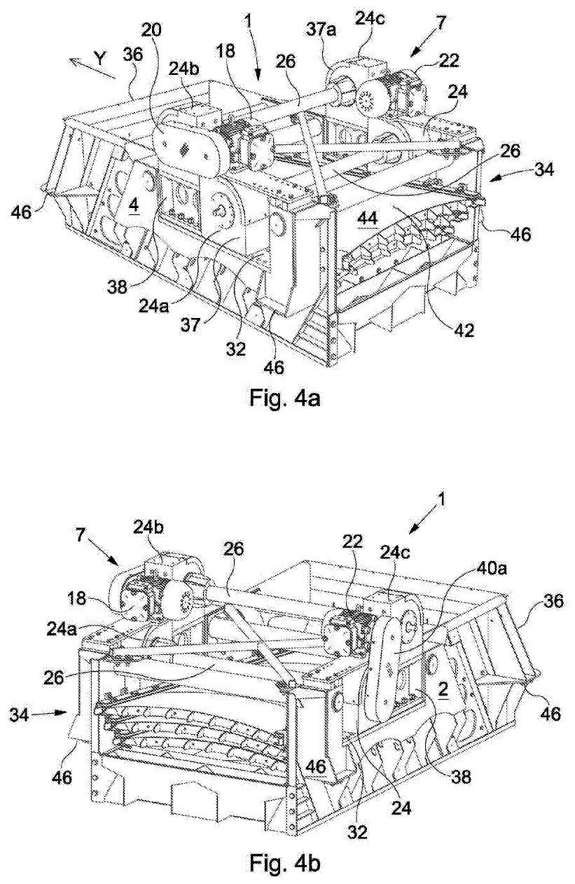

FIGS. 4a and 4b show in more detailed perspective views from either side; a basket and drive system of the type depicted in FIGS. 3a and 3b, to illustrate further the arrangements in a shale shaker basket 1.

In FIG. 4a a first drive arrangement 37 of drive system 7 has housings 24, 24a including eccentrically weighted shafts and coupled via a drive shaft in tubular housing 26. Drive is provided by electric motor 18 and belt drive 20 (located in a housing 40) on basket side 4.

The second drive arrangement 37a has housings 24b and 24c including eccentrically weighted shafts and coupled via a drive shaft in a second tubular housing 26. Drive is provided by electric motor 22 and belt drive 20 (located in a second housing 40a) on basket side 2.

The eccentrically weighted shafts of the drive arrangements 37, 37a are transverse to the front to rear direction of the basket suggested by arrow Y and also substantially horizontal.

In this example the second drive arrangement 37a is elevated by being mounted to the basket sides via platforms 38. Changing the relative positions of the drive arrangements along lowered edges 32 and/or their heights relative to each other can be used to adjust the vibratory motion (type and direction) imparted to the basket 1. In this example the drive arrangements 37, 37a are bolted to lowered edges 32 of basket 1.

Also shown in these views are the front, solids discharge end 34 of the basket, the rear, feed end 36; and a stack of three screen assemblies 42, one above the other.

The screen assemblies have screening surfaces 44 (only the topmost visible) for screening a drilling mud and drilling cuttings mixture applied at the rear, feed end 36.

The basket depicted has four mounts 46 for spring supports (not shown) on which it will sit to allow vibratory motion.

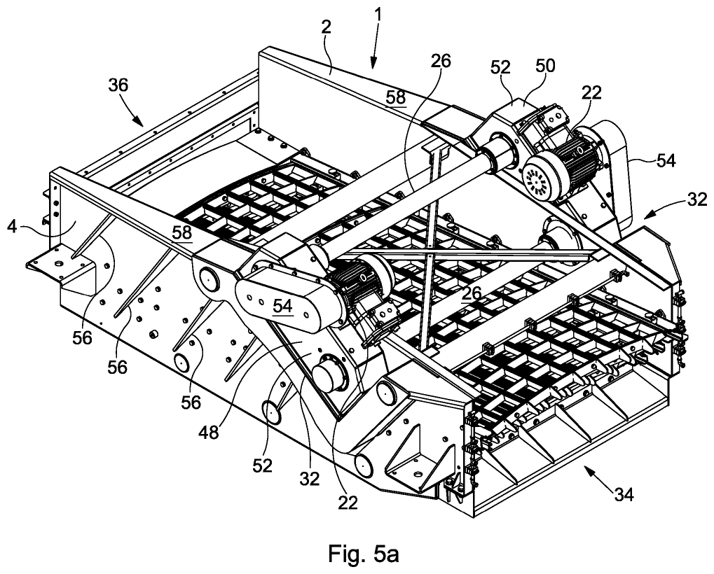

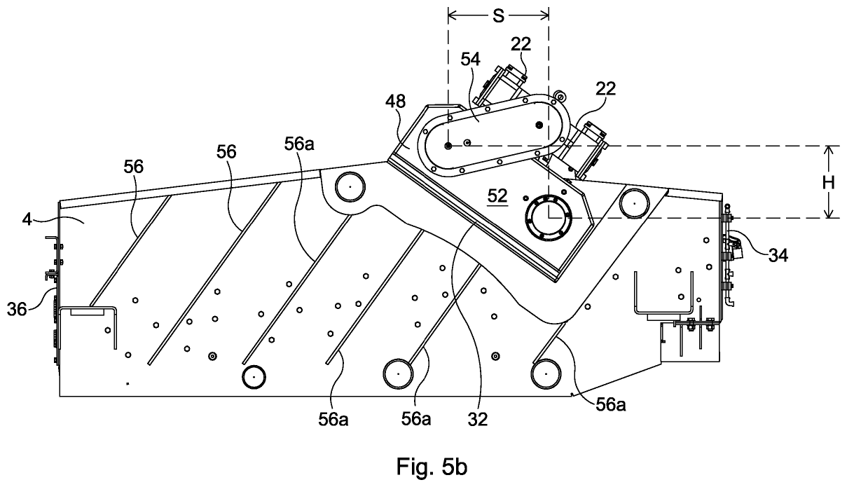

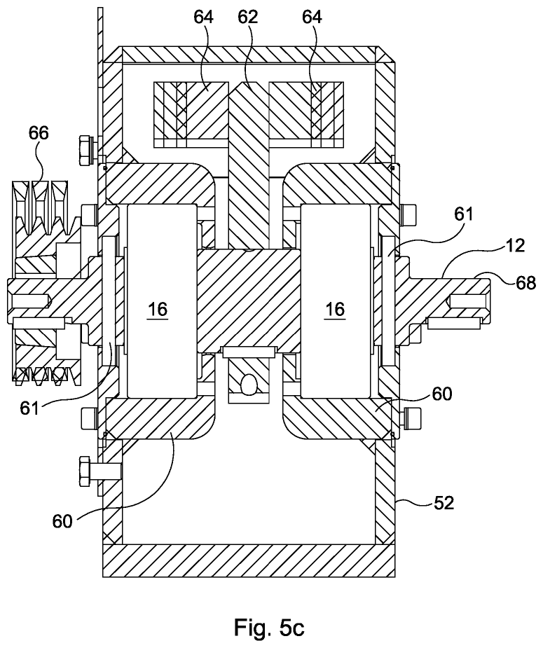

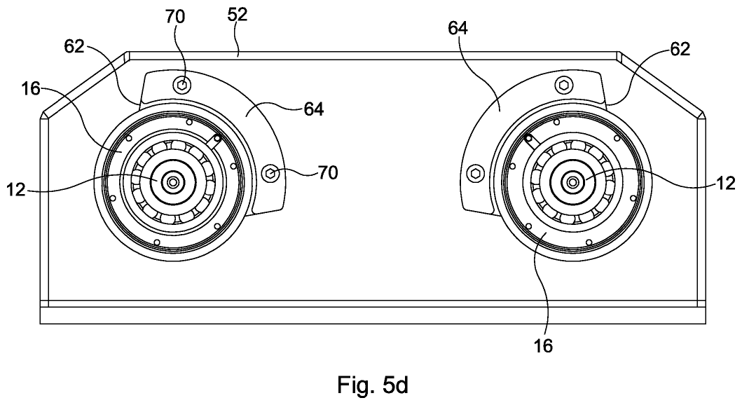

FIG. 5a shows in schematic perspective an alternative basket arrangement mounting modular drive arrangements. Basket 1 has sloping platforms 32 on each basket side 2, 4. In this example, platforms 32 have a generally V shape providing two upwards facing surfaces that are for supporting or locating bases or housings of modules 48, 50 mounted to respective basket sides 2,4.

The modules 48, 50 each have a main housing 52 that holds two eccentrically weighted shafts each mounted within the housing on bearings to either side of the eccentric weight as illustrated in FIGS. 5c,5d discussed below. On each module one of the eccentrically weighted shafts is driven by belts (inside belt housing 54) from electric motor 22. The other eccentrically weighted shaft in each module is driven by the drive shaft of a shaft drive inside one of the two tubings 26. The modules 48, 50 are identical and so can fit to either side 2, 4 of the basket 1.

The desired difference in height H and horizontal spacing S between the pairs of eccentrically weighted shafts within the housings of the modules 48,50 is determined by the slope of platform 32 and the spacing between the location of the shafts within main housing 52, as indicated in side elevation FIG. 5b.

Also visible in FIGS. 5a and 5b are a series of reinforcing ribs 56, 56a of sheet steel. The ribs are spaced apart and substantially parallel. The ribs 56a support platform 32, the ribs 56 support flanges 58 at the top edges of sides 2,4 towards feed end 36 of the basket.

The ribs slope downwards from the top edge of the basket side towards the bottom edge, in a direction towards the back (feed receiving end 36) of the basket. The downwards sloping angle, towards the back end 36 of the basket, approximates the typical angle of the vibratory motion that will be applied to the basket. Thus the ribs 56, 56a provide reinforcement to the basket sides.

FIG. 5c shows in schematic cross section a main housing 52 of a module to illustrate the mounting of one eccentrically weighted shaft 12. The shaft 12 is mounted in bearings 16 to either side. The bearings 16 are each themselves mounted in a housing 60 of the main housing 52 and protected by seals 61. Shaft 12 includes a radially extending arm 62 in between bearings 16 that mounts weights 64 to provide eccentric weighting. The weights 64 are distal to shaft 12 and extend axially from arm 62 (in the shaft direction). Each weight 64 extends to radially opposite the respective bearing 16.

The bearings 16 are close to and to either side of radially extending arm 62, providing a compact and durable arrangement.

The weights 64 can be unbolted from arm 62 and so replaced by different weights, to suit operational requirements. Drive to shaft 12 is by belts to pulley 66 mounted at one end. An electric motor (not shown in this figure) can provide the drive to the pulley. The opposite end 68 of shaft 12 will connect to a shaft drive, for example by a universal joint, in use.

FIG. 5d shows the main housing 52 of FIG. 5c in side elevation cross section showing the two eccentrically weighted shafts 12 within the housing 52. In this view the radially extending arms 62 on shafts 12 can be seen to be part circle in form, as are the weights 64. Bolts 70 hold the weights 64 on to arms 62. The two arms 62 extend radially from their corresponding shaft 12 at different angles, to provide the desired vibratory action in use.

1. A basket for a shale shaker, the basket comprising a front, solids discharge end and a rear, feed end spaced apart by opposed first and second sides;
wherein the first and second sides mount a drive mechanism comprising:
a) a first eccentrically weighted shaft, mounted to the first side of the basket for rotation about an axis transverse to the front to rear direction of the basket;
b) a first shaft drive, coupled to the first shaft and to;
c) a corresponding second eccentrically weighted shaft, mounted to the second side of the basket for rotation about an axis transverse to the front to rear direction of the basket;
wherein at least the first shaft drive includes at least one coupling accommodating misalignment between the first and second eccentrically weighted shafts.

2. The basket according to claim 1 wherein the drive mechanism further comprises:
d) a third eccentrically weighted shaft, mounted to the first side of the basket for rotation about an axis transverse to the front to rear direction of the basket;
e) a second shaft drive, coupled to the third shaft and to;
f) a corresponding fourth eccentrically weighted shaft, mounted to the second side of the basket for rotation about an axis transverse to the front to rear direction of the basket.

3. The basket according to claim 1 wherein the eccentrically weighted shafts are each mounted for rotation about a horizontal axis transverse to the front to rear direction of the basket.

4. The basket according to claim 1 wherein the eccentrically weighted shafts are each mounted so as to have the eccentric weighting in the plane of the corresponding first or second basket side.

5. The basket according to claim 4 wherein the eccentrically weighted shafts are each mounted so as to have the centre of mass of the eccentrically weighted shaft in the plane of the corresponding first or second basket side.

6. The basket according to claim 1 wherein further comprising a motor configured to drive the first shaft and which is mounted to the first side of the basket.

7. The basket according to claim 2 wherein further comprising a motor configured to drive the first shaft and which is mounted to the first side of the basket and a second motor configured to drive the fourth shaft and which is mounted to the second side of the basket.

8. (canceled)

9. The basket according to claim 2 wherein both the first and second shaft drives each have at least one coupling accommodating misalignment between the respective first and second pair and third and fourth pair of shafts.

10. The basket according to claim 2 wherein:
a) the first shaft drive comprises a first drive shaft coupling at a first end to the first shaft and at a second end to the second shaft; wherein the couplings are universal joints or constant velocity joints; and
b) the second shaft drive comprises a second drive shaft coupling at a first end to the third shaft and at a second end to the fourth shaft; wherein the couplings are universal joints or constant velocity joints.

11. The basket according to claim 1 wherein the shafts of the shaft drive or drives are tubes.

12. The basket according to claim 1 wherein the eccentrically weighted shafts are each in a respective housing.

13. The basket according to claim 2 wherein the first and third eccentrically weighted shafts are mounted for rotation in a common housing or to a common base; and wherein the second and fourth eccentrically weighted shafts are mounted for rotation in a second common housing or to a second common base.

14. The basket according to claim 1 wherein the shafts of the shaft drive or drives are provided with housings.

15. The basket according to claim 1 wherein the eccentrically weighted shafts are mounted for rotation in bearings to either side of the respective shaft.

16. The basket according to claim 1 wherein eccentric weighting for an eccentrically weighted shaft is provided by a radially extending arm on the shaft.

17. The basket according to claim 16 wherein the radially extending arm carries a weight or weights, distal to the eccentrically weighted shaft.

18. The basket according to claim 16 wherein the weighting of the radially extending arm extends axially.

19. The basket according to any one of claim 16 wherein the eccentrically weighted shaft is mounted for rotation in bearings to either side of the radially extending arm.

20. The basket according to claim 1 wherein the first and second sides of the basket each comprise a platform for mounting a base or a housing for an eccentrically weighted shaft.

21.-25. (canceled)

26. The basket according to claim 20 wherein the platform is sloped from the horizontal.

27. The basket according to claim 26 wherein the platform is V shaped, with each arm of the V providing an upwards facing surface for supporting or locating a base or a housing.

28. The basket according to claim 1 wherein the first shaft drive comprises a relatively lighter weight material than the material of the first and second eccentrically weighted shafts.

29. The basket according to claim 13, wherein the common housing is modular and configured for location on either side of the basket.

30. A drive mechanism for the basket of a shale shaker comprising:
a) a first shaft, eccentrically weighted and mountable in use to a first side of a shale shaker basket, for rotation about an axis transverse to the front to rear direction of the basket;
b) a first shaft drive, coupled to the first shaft and to;
c) a corresponding second eccentrically weighted shaft, mountable in use to a second side of the shale shaker basket, opposite the first side, for rotation about an axis transverse to the front to rear direction of the basket,
wherein at least the first shaft drive includes at least one coupling accommodating misalignment between the first and second shafts.

31. The drive mechanism of claim 30 further comprising:
d) a third eccentrically weighted shaft, mountable in use to the first side of the shale shaker basket for rotation about an axis transverse to the front to rear direction of the basket;
e) a second shaft drive, coupled to the third shaft and to;
a corresponding fourth eccentrically weighted shaft, mountable in use to the second side of the basket for rotation about an axis transverse to the front to rear direction of the basket.

32. A drive module for a basket of a shale shaker, the drive module comprising two eccentrically weighted shafts mounted on bearings in a single housing and configured for mounting to the first side or the second side of a shale shaker basket so as to provide either the first and third, or the second and fourth, eccentrically weighted shafts of a drive mechanism in accordance with claim 31.
